(19) United States
(12) Patent Application Publication
(10) Pub. No.: US 2024/0345274 A1
(43) Pub. Date: Oct. 17, 2024

(54) ISOMORPHIC CLOUD DATA TRANSFER FROM A LOCATING INSTRUMENT

(71) Applicant: Metrotech Corporation, Santa Clara, CA (US)

(72) Inventor: William Moore, Umberleigh (GB)

(21) Appl. No.: 18/632,649

(22) Filed: Apr. 11, 2024

Related U.S. Application Data
(60) Provisional application No. 63/496,164, filed on Apr. 14, 2023.

(51) Int. Cl. G01V 3/08; H04W 64/00

(52) U.S. Cl. CPC G01V 3/081; H04W 64/006

(57) ABSTRACT

According to some embodiments, an underground line locator system is presented. In accordance with some embodiments, an underground line locator system includes a locator including an array of spaced apart low frequency magnetic sensors that receives signals, including magnetic signals emanating from an underground cable or pipe; and a communication system that provides communications with a cloud-based platform that receives and stores data that includes the signals, wherein the data transmission is an isomorphic data transmission. In some embodiments, the communications system is a WiFi system.

### RELATED APPLICATIONS

This application claims priority to U.S. Provisional Application 63/496,164, filed on Apr. 14, 2023, which is herein incorporated by reference in its entirety.

### TECHNICAL FIELD

Embodiments of the present invention are related to underground line location and, in particular, to underground locators with web-based isomorphic cloud data transfer.

### DISCUSSION OF RELATED ART

The process of locating buried utilities (pipes and cables) using low frequency signals is well known and widely adopted as a work practice. Line locating instruments typically include an array of spaced antennas that receive time-varying magnetic field signals generated by the underground utility itself. Such signals can be the result of currents coupled into the underground utility by a separate transmitter or are inherent in the underground utility, for example from power lines. The array of spaced antennas in the line locating receiver receives the magnetic fields emanating from the underground line, which are often at specific frequencies. Processing electronics in the line locating receiver determines the relative utility position from the line locating system, including depth, signal currents and other information, based on signals related to the magnetic fields. Horizontal position and depth of the underground utility relative to the line locating receiver, for example, can then be displayed to the user and, in some systems, recorded relative to the position of the line locator receiver.

Recent developments in the utility industries have placed significant emphasis on logging data to cloud-based webservers and data bases. Such data can be used for various synergistic reasons and are accessible for analysis by multiple users. These reasons may include, for example, creation of digital maps of the underground utility, post survey analysis, proof of due diligence, and assessment of the locate process data for training purposes. Creation of the digital maps includes creating a map showing the position of buried utilities with respect to a defined geospatial grid reference. The current standard used for geographic based mapping, WGS84, is an Earth-centered, Earth-fixed coordinate system used in geocentric navigation. Recent developments in satellite positioning systems, the global navigation satellite system (GNSS), facilitate pinpointing a global positioning satellite (GPS) receiver to within a positional accuracy of only a few centimeters. Such a receiver can be fixed to the underground line locator receiver to facilitate geographic location of the underground line locator. Enhanced positioning, for example Real Time Kinematic (RTK), can be used in conjunction with geo-spatial information and enhance the position accuracy in real-time—true ‘on-the-fly’ positioning with a horizontal accuracy of ±10 cm RMS or less (e.g., ±1 cm RMS)—of the underground line locator receiver, and therefore the underground line being located.

Once the digital map of the underground utilities is uploaded, post survey analysis to assess and improve the map data can be performed. This analysis may, in some instances, result in recommendations for further on-site surveys to improve the digital map or recommendations for acquisition of further data to better determine the location of the underground utility.

Another reason for uploaded mapping data is that it provides proof of due diligence. Often, a ticketing system is implemented which directs an operator to locate the underground lines in a particular geographic area. The uploaded mapping data can be used to determine if the ticket has been appropriately fulfilled. Consequently, the mapping data can be used to determine whether or not the correct survey type and procedure have been performed at the defined geographic location of the ticket.

Additionally, the mapping data can be used for assessment training purposes. An assessment of the locator's inertial sensor data to check that the locator is being held and moved within the optimal recommended set of parameters can be performed. This data can be used to provide feedback to the operator to improve location processes, or to reject data that was taken while the locator receiver is not operated appropriately.

In any of these purposes, the timely upload of data from the locate receiver to the cloud-based server is performed. Consequently, there is a need to develop systems for transportation methodologies for sending data to, or exchanging data with, a cloud-based webserver and database.

### SUMMARY

According to some embodiments, an underground line locator system is presented. In accordance with some embodiments, an underground line locator system includes a locator including an array of spaced apart low frequency magnetic sensors that receives signals, including magnetic signals emanating from an underground cable or pipe; and a communication system that provides communications with a cloud-based platform that receives and stores data that includes the signals, wherein the data transmission is an isomorphic data transmission. In some embodiments, the communications system is a WiFi system. In some embodiments, the communication system includes a mobile device communicating with the locator and providing WiFi connection with the cloud-based platform. In some embodiments, the locator includes a Real Time Kinetic GNSS system for position location on the earth's surface. In some embodiments, the locator receives RTK correction data from a ground base station or alternative GNSS corrections. In some embodiments, the locator communicates with a Cloud Webserver that includes an Internet-Of-Things (IOT) platform. In some embodiments, the communications system uses attribute-value pairing formats for data interchanges. In some embodiments, the communications system can include a smart phone communicating with the locator.

In some embodiments, a method of transmitting data from a line location receiver includes acquiring data; determining a locate vector from the data; determining isomorphic data from the locate vector; and transmitting the isomorphic data. In some embodiments, transmitting the isomorphic data includes transmitting the isomorphic data using WiFi. In some embodiments, transmitting the isomorphic data includes transmitting the isomorphic data to a mobile device. In some embodiments, acquiring data includes acquiring locate data, operational data, and geolocation data.

In some embodiments, a locate receiver is presented that includes a magnetic sensor array; a processing circuit coupled to the magnetic sensor array; a GPS antenna coupled to the processing circuit; a communications interface coupled to the processing circuit; and a memory coupled to the processing circuit, the memory storing instructions executable by the processing circuit to acquire data from the magnetic sensor array and the GPS antenna, determine a locate vector from the data, determine isomorphic data from the locate vector, and transmit the isomorphic data through the communications interface. In some embodiments, the locate receiver includes inertial sensors and wherein instructions to acquire data further include instructions to acquire data from the operational sensors. In some embodiments, the communications interfaces includes a WiFi interface. In some embodiments, the communications interface includes a Bluetooth interface to isomorphically transfer data to a mobile device.

These and other embodiments are discussed below with respect to the following figures.

### BRIEF DESCRIPTION OF THE FIGURES

FIG. 1 illustrates a locator receiver communicating with a cloud-based data system.

FIG. 2 illustrates an example of a locator receiver equipped with RTK GNSS system.

FIG. 3 illustrates a locator receiver communicating with a cloud-based Internet-of-Things (IoT) Platform.

FIG. 4 illustrates an implementation to provide positional data to a cloud-based system according to some embodiments of the present disclosure.

FIG. 5 illustrates WiFi implementation enabling a TCP/IP Socket to a cloud-based IoT platform according to some embodiments of the present disclosure.

FIG. 6 illustrates a Bluetooth enabled full system functionality and connectivity according to some embodiments of the present disclosure.

FIG. 7 illustrates a locator receiver according to some embodiments of the present disclosure.

FIG. 8 illustrates a method of operating the locate receiver illustrated in FIG. 7 according to some embodiments of the present disclosure.

These figures along with other embodiments are further discussed below.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description illustrates inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

Embodiments of the present disclosure include overlaying a cloud-based data connectivity system that may include RTK GNSS for use with a utility cable locating instrument such as an underground line location receiver. Embodiments make use of one or more radio frequency (RF) communication methods including, but not limited to, WiFi, Bluetooth, and Cellular Networks (LTE, 5G, or other standards), along with an isomorphic data transfer. Embodiments include automatic data synchronization with a cloud-based webserver and data base. By also allowing off-line data logging it is possible to manage the problems of self-noise, which otherwise erode the quality of the location measurements, while maintaining the cloud-based databases.

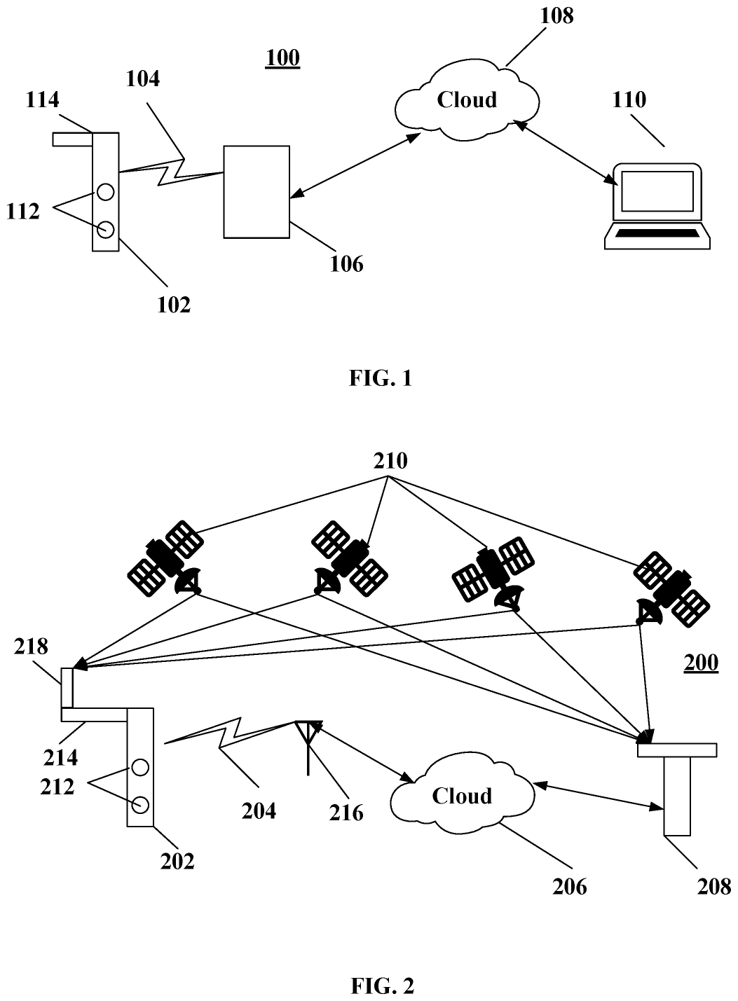

FIG. 1 shows a system 100 with underground line locate receiver 102 communicating with a cloud-based webserver 108. As illustrated, locate receiver 102 may include a number of low frequency magnetic sensors 112 used for the actual locating task, a standard precision GPS device and a Bluetooth transceiver can be included in electronics 114 of locate receiver 102. Locate receiver 102 can, therefore, communicate with a mobile device 106 via Bluetooth 104 to provide data to a cloud-based webserver 108. This system 100, therefore, communicates to cloud-based webserver 108 via a mobile device 106. Mobile device 106 may, for example, be operating a proprietary application that has been installed, for example ‘VMMAP’ available from Vivax-Metrotech Corp. Mobile device 106 may, for example, by a cell phone, tablet, laptop, or any other mobile communicating device configured to perform the described functions.

As is shown in FIG. 1, locator 102 includes magnetic sensors 112 and electronics 114. Magnetic sensors 112 can include multiple individual coils oriented to detect the magnetic field in particular directions. For example, magnetic sensors 112 can include one or more 3-D (or tri-coils) configured to measure fields in multiple directions around a common point (e.g., three orthogonal axis). Electronics 114 can include all electronics to receive signals from the magnetic sensors 112 and process the signals. Electronics 114 can further include a user interface as well as communications interfaces that are configured so that locator receiver 102 can communicate as discussed with other devices. Locate receiver 102, then, can detect magnetic fields that emanate from an underground line and analyze those magnetic field signals to determine the location of the underground line relative to locate receiver 102.

Locate data (e.g. data that can be used to locate the underground utility relative to locate receiver 102) and data related to operation of locate receiver 102 (e.g., inertial data, environmental data, etc.) is generated by locate receiver 102. GNSS data, however, can be generated from mobile device 106 or from an internal GPS receiver that is part of electronics 114 in locating receiver 102. Using a GPS receiver that is included in electronics 114 of locating receiver 102 has the advantage that it defines the true position of the locating receiver 102 rather than that of the mobile device 106.

In the example illustrated in FIG. 1, the data logs, with locate data, operational data, and GNSS data, are sent to mobile device 106 using an open loop Bluetooth protocol 104. In mobile device 106, data is formatted and subsequently sent to cloud-based webserver 108. In some examples, cloud-based webserver 108 can include a Microsoft Azure flexible cloud computing platform, but other suitable computing platforms can be used. The data logged in cloud-based webserver 108 can be downloaded for further processing in computer 110.

The data records generated and sent to cloud-based webserver 108 can be initiated by a variety of events, for example a user-initiated event. In some examples, the operator of line locate receiver 102 selects a real position on the ground holding the tip of the locator receiver 102 at a point directly over the buried utility. The user can then initiate data transfer to the cloud-based servers 108.

Many locate receivers, including locate receivers according to embodiments of the present disclosure, transfer various types of data to cloud-based servers. Although in general, any data format can be used, a useful format for transfer of data, and the types of data being transferred, is described below.

Data that is transferred between a locate receiver and a cloud-based server can be formatted as a set of locate vectors, which are generated and pushed to the cloud-based servers by the locate receiver. Locate vectors are arrays of location-based data that characterize and locate the underground utility. The locate vectors can include, but are not limited to, a timestamp, the measured depth of the buried utility, the measured determination of the signal current in the underground line, and the determined geopositioned location (Latitude and Longitude). In some examples, the timestamp can be a UNIX style UTC formatted data word.

Further, the locate vectors can include event logs. Event Logs are generated by the environmental, physical circumstances, or physical characteristics of operation of the location receiver, which can be detect using sensors that are included in the locate receiver. For example, the event logs of the locate vectors can include the signal-to-noise ratio of the measured magnetic signal, which gives a good indicator of the quality of the accompanying data set in the locate vectors. These event logs may also include, for example, information regarding the motion of locate receiver during the locate (e.g., inertial sensing data), indications of cable locations relative to the locate receiver, or issues regarding the received signal. Further information may include environmental conditions (temperature, moisture, etc.) that can be detected by the locate receiver.

The event logs can also include data regarding the motion of locate receiver to evaluate the quality of the locate procedure being used. In particular, the locate receiver can detect if it is moving too quickly, which may result in a warning to show that the locate receiver is working outside normal recommended parameters. Further, the locate receiver can detect if it is being held at the wrong angle, which causes the depth and current information to be compromised. Additionally, the locate receiver can detect whether there is too much swing in the motion. Ideally, the locate receiver should be moved across the locating point, not swing past it like a pendulum mechanism.

Additionally, the event logs can include further information about the located cable or other interferences in the area of the locate. For example, the locator receiver can detect a shallow cable (i.e., a cable detected at a depth that is below a threshold depth) and a warning generated. An overhead cable can also be detected and a warning to the user is generated. The locate receiver can also detect signal overload, which typically occurs when the locate receiver is too close to a power transformer causing the magnetic field sensors to overload and become non-linear.

The locate vector can also include status information. The status information can be generated automatically by the locate receiver whenever a new survey is started and whenever the locate receiver operating mode is changed. The status information can be used to check whether users are following the defined work practices. The status information can include, for example, locator operating mode, calibration verification, time scheduled data logs, or other operating information.

In many examples, the locate receiver may have multiple operating modes. Locate operating modes, for example, can include survey type modes, power mode locating types, long wave radio locating types, and active mode locating types. Multiple operating modes may also include calibration status, which indicates whether the locate receiver is within a pre-defined calibration period for the mode in which it is operating.

In some examples, the locate receiver can perform calibration verification, which is an integrated self-test that can check the calibration accuracy of its analogue and digital measurement circuits. The raw measurements of the calibration verification, and the acceptable limits, can be transferred to the cloud-based servers within the locate vector.

Further, the locate receivers can implement time scheduled data logs. A time scheduled data log can be a continuous data stream generated at a predefined data rate, for example once per second. The data content may include the above defined or a selected subset of the data described.

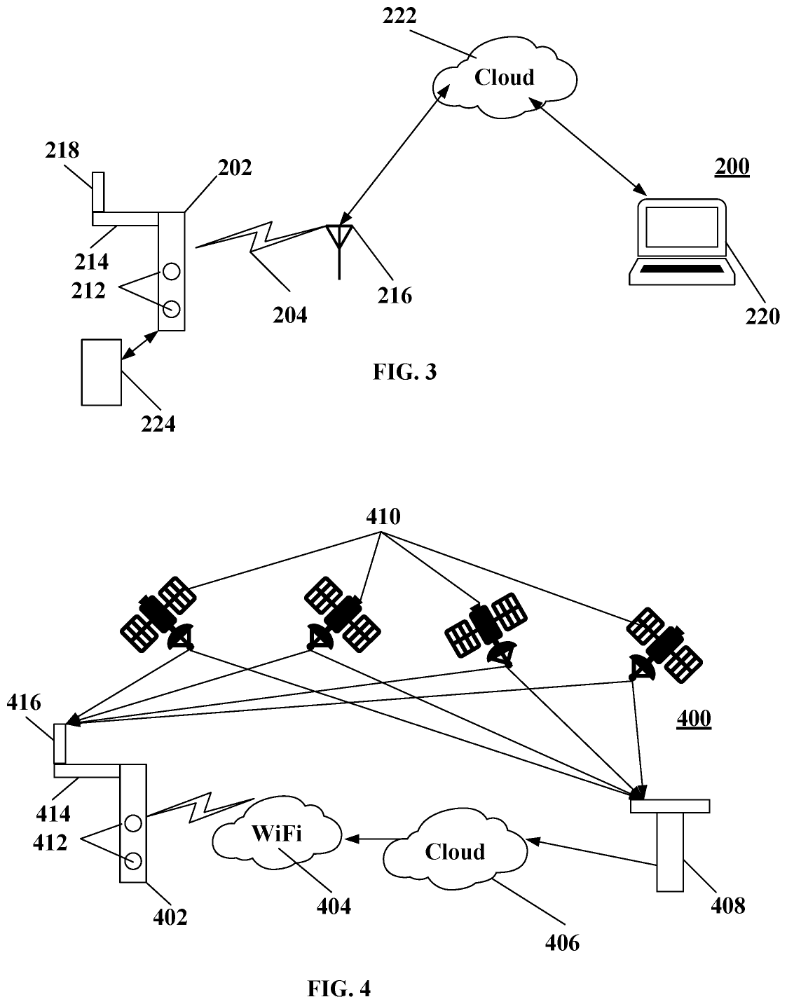

FIGS. 2 and 3 show a more sophisticated locating instrument system 200 that can also acquire data as described above. In the example illustrated in FIG. 2, locate receiver 202 can be equipped with six (6) low frequency magnetic sensors 212, an real-time kinetic (RTK) GNSS receiver 218, and a cellular LTE mobile device. The LTE device of locator 202 can transfer data through the LTE protocol 204 with LTE cell tower 216 using the LTE device in locator 202 to transmit data to and from the cloud-based web-server 222 (FIG. 3) and simultaneously receive RTK correction data from a Networked Transport of Radio Technical Commission for Maritime Services (RTCM) data via Internet Protocol (NTRIP) GNSS Base Station 208 from NTRIP caster web service 206. LTE protocol 204 can, for example, use a TCP/IP RTCM3 (binary) stream. As shown, NTRIP Base Station 208, which communicates with NTRIP web server 206, and locate receiver 202, through RTK receiver 218, are both in communications with GNSS satellite array 210 to provide location information.

As shown in FIG. 3, in this application all data logs are initially stored in a mass storage device 224 that is coupled to receive data from locate receiver 202. Examples of storage device 224 can include an SD Card or an eMMC device. The LTE network 204 can, for example, deploy protocol buffers allowing data stored on cloud-based server 222 and the stored locator data stored on storage device 224 to be synchronized at any time a TCP/IP socket is open (i.e., an LTE signal 204 from tower 216 is present). The protocol buffers are highly extensible allowing other data features such as Firmware Over-the-Air (FOTA) to be available and downloaded to update locate receiver 202. Other interchange formats such as JavaScript Object Notation (JSON) or any attribute-value pairing mechanism could equally well be used.

In some examples, cloud-based servers 222 can implement the Microsoft Azure Internet of Things (IoT) Platform, which is a collection of managed cloud services that connect, monitor and control IoT assets. In this case an interactive communication with the cloud-based servers 222. Cloud-based servers 222 can, for example, use TLS1.2 TCP/IP (HTTPS) protobuf (binary) payloads over the LTE network. Existing systems also allow Firmware-Over-The-Air (FOTA) updates to the locating system firmware on locate receivers 202.

In other applications, the data that is stored in cloud-based servers 222 can be used to perform follow-up surveys. For example, “Walk-Back” coordinates of latitude and longitude can be predefined in the data structure stored in cloud-based servers 222 and the locating system be programmed to give directional guidance back to an exact point in a digital map from which previous data had been acquired. Again, a computer 220 can be used to further process data records logged into cloud-based server 222.

The systems illustrated in FIGS. 1-3, however, have several identified problems as indicated below. As the expectations of wide data connectivity have evolved and increased, various problems have been encountered. While a cellular LTE network can simultaneously and cooperatively manage data corrections for an RTK GNSS and cloud-based data exchanges using TCP/IP, this is not the case for a bandlimited Bluetooth devices connected to a UART. Furthermore, the existing data transfer mechanisms, for example NMEA Strings used in GPS decoding, are not well suited to automatic synchronization with cloud-based data—and this is an identified problem with various users.

Additionally, existing electromagnetic utility locators with wireless data interfaces suffer from noise interference to the signals received from the buried utilities by means of integrated sensors and signal processing subsystems. A typical sensitivity is the detection of a 1 μA signal current at a 1 m depth. Consequently, a small interference close to the sensors can damage the measurement, it also increases the difficulty for the operator to locate deep utilities, or utilities where the signal is weak.

Further, the pulsed nature of the wireless RF transmissions results in pulsed currents drawn from the power supply. The wiring environment of the power supply and battery, which source these pulsed currents, give rise to corresponding pulsed magnetic fields and often contain frequency components which fall within the bandwidth of detection—the locator's primary function. As an example, it has been noted that a live cellular LTE data stream caused 25 dB loss of signal-to-noise ratio on a locating signal at 1024 Hz referred to a 5 Hz detection bandwidth.

Embodiments of the present disclosure address many of these issues and are illustrated in FIGS. 4-6. In particular, embodiments of the present disclosure provide for an isomorphic data transfer mechanism, which allows for many possibilities of data exchanges between a locating receiver Instrument and a cloud-based server. In some embodiments, use of the protocol buffers gives a language and platform neutral mechanism allowing serialized data structures to automatically synchronize. Such data structures are highly extensible, which can allow for applications that utilize remote off-line data analysis.

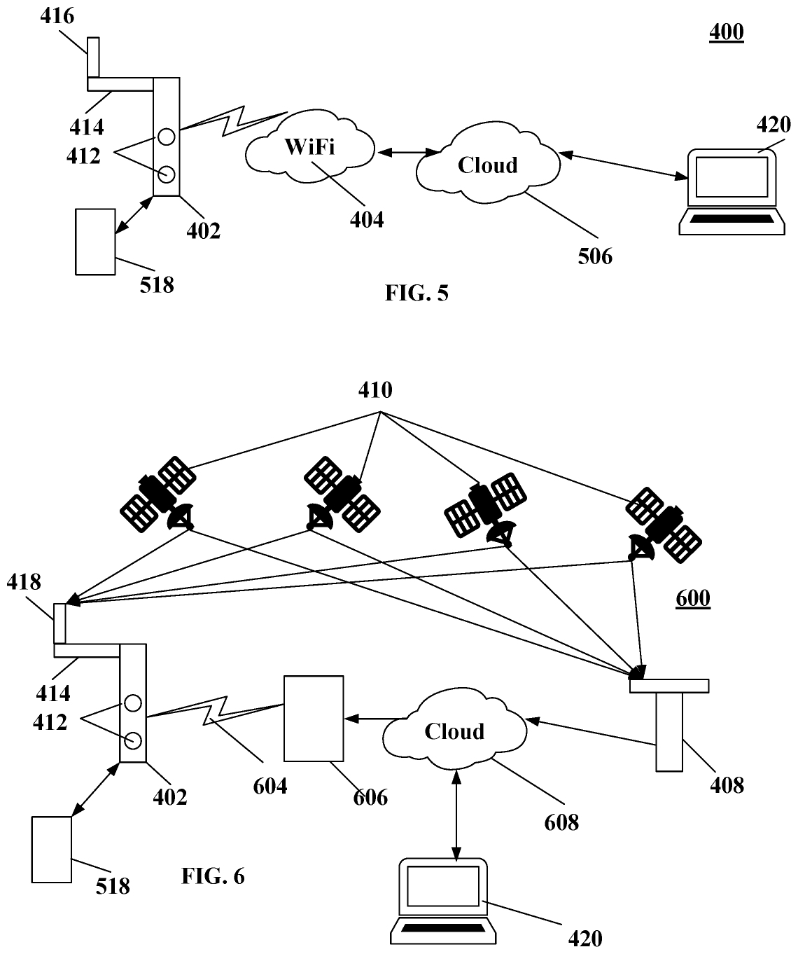

Isomorphic data transformations allow the same data transactions to operate independently of the communication mechanism. A data transaction in this context, can be the transfer of any structured data, such as the locate vectors discussed above. The communication mechanism can be any wave based medium; Wifi, Bluetooth and Cellular networks are relevant examples. Isomorphic data transformations allow communications method overlay such that a data transaction may start in one medium and be continued or completed in a plurality of different media. For example, a data transactions may start via a cellular network, then lose the connection, next to be continued on Wifi and finally completed via Bluetooth. Consequently the communication method can allow any combination of overlays and any amount of interruption, fragmentation, or information extension. As such, embodiments of the disclosure can take the form of a ‘method overlay’ which is made possible by the intrinsic isomorphic properties of the serialized data. Various radio communication mediums fit within these embodiments. FIGS. 4 and 5, for example, show examples of a WiFi implementation to either replace the LTE Cellular Network or work in conjunction with that network. The Cell Network is not restricted to LTE and may be configured using any of the following available RF technologies: GSM, EDGE, UMTS, HSDPA/HSUPA.

FIG. 4, for example, illustrates a system 400 using a WiFi implementation. As illustrated in FIG. 4, for example, locate receiver 402 receives GNSS data from NTRIP source 408 through NTRIP caster 406 via a WiFi network 404. As before, both locator 402 and NTRIP source 408 are in communications with a GNSS satellite array 410.

As shown in FIG. 4, locate receiver 402 includes magnetic sensors 412, electronics 414 that receives and processes signals from magnetic sensors 412, and a GPS receiver 416. In the example illustrated in FIG. 4, GPS receiver 416 can be an RTK receiver and locate receiver 402 receives signals from NTRIP source 408 through NTRIP caster 406 via WiFi network 404.

As previously discussed, locate receiver 402 can then receive magnetic fields emanating from an underground line with magnetic field sensors 412, which may be an array of spatially separated sensors. The array of magnetic field sensors 412 may include one or more 3D sensors that detect the magnetic field in three orthogonal directions. Data from magnetic field sensors 412 is then analyzed in electronics 414, along with data from other sensors on locate receiver 402 (e.g., inertial sensors and environmental sensors). RTK receiver 416 receives data from GNSS satellite array 410 and from NTRIP source 408 to precisely determine the geographic location of locate receiver 402.

FIG. 5 illustrates further aspects of system 400. As illustrated in FIG. 5, locator 402 can store data on a storage device 518 and communicates via WiFi 404 with cloud-based server 506. Cloud-based server 506, for example, can execute Microsoft azure to store the data in a data base. Computer 420 can retrieve data from cloud-based servers 506 for further analysis.

As is discussed above, locate receiver 402 transmits the locate vectors as described above utilizing an isomorphic data transfer. As discussed above, isomorphic overlays can be equally used across multiple protocols of wireless data transfer. Isomorphic overlays such as that described above can be equally used with Bluetooth, although the intrinsic bandwidth is lower for Bluetooth Low Energy (BLE).

In the example illustrated in FIGS. 4 and 5 the cloud connectivity can be performed through an application on locate receiver 402, for example via the VMMAP App, but the method of data system overlay still applies.

In some embodiments, a mobile device such as a smart phone, can provide a direct access point to the cloud, thus circumnavigating the requirement for the IoT Platform hosted by Microsoft Azure. FIG. 6, for example, shows these data transactions, in this instance where the isomorphism is facilitated in the application executing on a mobile device acting as the NTRIP client and managing the cloud connectivity.

As illustrated in FIG. 6, locate receiver 402 can communicate through Bluetooth 604 to a mobile device 606. As discussed above, mobile device 606 runs an application, for example the VMMAP App, and communicates with cloud servers 608. Cloud servers 608 can include cloud storage, for example Microsoft Azure, and a NTRIP Caster. NTRIP source 408, which is in communication with GNSS satellite array 410, can provide data to cloud-based servers 608 for communication through mobile device 606 to locate receiver 402. Locate receiver 402 can also be in communications with GNSS satellite array 410. Locate receiver 402 can also include data storage 518, wherein data stored in cloud-based server 608 can be synchronized periodically when mobile device 606 is communicating, for example by WiFi, with cloud-based server 608.

The isomorphic data overlay helps the problems of RF induced interference by allowing off-line and on-line operations to co-exist. Log files can be synchronized at any time following a locate survey, the only requirement being to have either an LTE Cellular option, a WiFi enabled option or Bluetooth with the mobile device operating an application. Streaming the RTCM correction data for RTK using Bluetooth or WiFi options has been shown to reduce the overall interference as compared to using the LTE Cellular option.

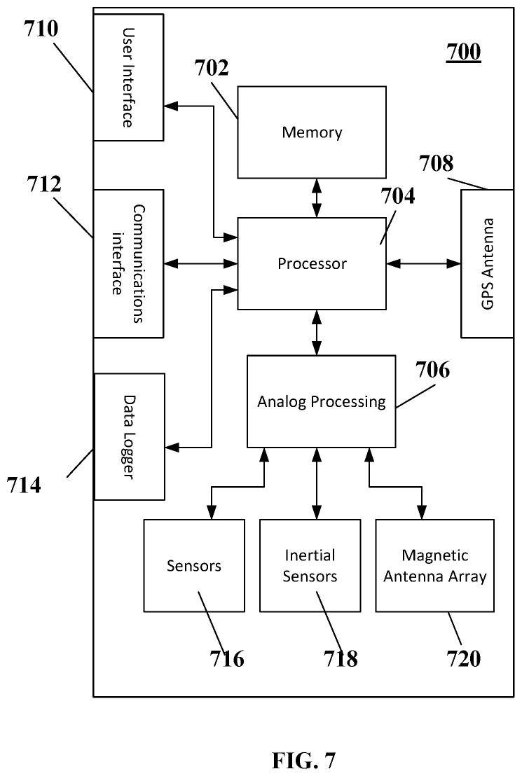

FIG. 7 illustrates a locate receiver 700 according to some embodiments of the present disclosure. As illustrated in FIG. 7, locate receiver 700 includes a processor 704. Processor 704 can be any processing device that is capable of executing instructions to perform the functions described here.

Processor 704 is coupled to memory 702. Memory 702 can be any combination of volatile and non-volatile memories. Memory 702 stores programming instructions that are executed by processor 704 and data. As is suggested above, programming instructions stored in memory 702 may be updated periodically with new instructions received by locate receiver 700.

Processor 704 further receives digitized signals related to the location of an underground utility or operation of locate receiver 700. As is illustrated in FIG. 7, processor 704 is coupled to receive digitized data from an analog processing circuit 706, which includes analog-to-digital conversion. Analog processing 706 receives signals from one or more sensors. For example, the one or more sensors can include magnetic field detectors, inertial sensors, and environmental sensors.

As shown in the example locate receiver 700, analog processing 706 can be configured to receive and processes signals from magnetic antenna array 720. As has been previously discussed, magnetic antenna array 720 can include one or more antennas capable of measuring the magnetic fields in defined directions relative to locate receiver 700. In particular, magnetic antenna array 720 can include one or more 3-D coil arrangements that are spatially separated to provide data to processor 704 that allows for precise location of the underground utility relative to the locate receiver 700.

As is further illustrated in FIG. 7, analog processing 706 can be configured to receive signals from inertial sensors 718. Inertial sensors 718 can include an array of accelerometers, for example, that can measure the motion of locate receiver 700.

Additionally, analog processing 706 can be configured to receive signals from sensors 716. Sensors 716 can include one or more environmental sensors. Environmental sensors can, for example, measure parameters regarding the condition of locate receiver 700. These sensors can, for example, include measurement of temperature, power source condition, or other conditions.

Analog processing 706 receives the signals from sensors 716, inertial sensors 718, and magnetic antenna array 720 and provides corresponding digital signals to processor 704. As such, analog processing 706 may include filters, amplifiers, integrators, and other analog circuits that are appropriate for processing the signals received from the sensors in sensors 716, inertial sensors 718, and magnetic antenna array 720.

Processor 704 is further coupled to receive geolocation data from GPS antenna 708. As discussed above, GPS antenna 708 may be regular GPS antenna or can, for more accuracy, be an RTK antenna. As an RTK antenna, further data is received by locate receiver 700 to correct the location signals received from GPS antenna 708.

Processor 704 can, in some embodiments, be coupled to a data logger 714 or other storage device. As discussed above, locate data, including the data from GPS antenna 708, magnetic antenna array 720, inertial sensors 718, and sensors 716, may be stored in data logger 714. Data stored in data logger 714 can be stored and transmitted to a cloud-based server at a later time or data logger 714 can be used as a buffer during a continuous transfer of data from locate receiver 700 to a cloud-based server.

Processor 704 is further coupled to communications interface 712. Communications interface 712 includes antennas and other electronics to transmit and receive digital data. Communications interface 712 can be, for example, compatible with one or more of a WiFi standard or a Bluetooth standard. In some cases, a cell-phone RF standard can be implemented. As discussed above, processor 704 can transmit locate data, either continuously or by reading the data from data logger 714, to a cloud-based server. As discussed above, processor 704 transmits isomorphic data. As shown in FIGS. 4 and 5, communications interface 712 can communicate through WiFi to cloud servers 406 and 506. In that case, processor 704 may execute a program such as VMMAP as discussed above. In some embodiments, as shown in FIGS. 6, communications interface 712 can communicate with mobile device 606, which then transmits the data to cloud-based servers 608.

As is further illustrated in FIG. 7, processor 704 is coupled to user interface 710. Locate data as well as well as messaging and other information can be conveyed to the user with user interface 710.

Locate receiver 700 can be any of a number of locator platforms that are configured to execute instructions according to embodiments of the present disclosure. Among the locators that can be used are the Vscan and VscanPro devices produced by Vivax-Metrotech.

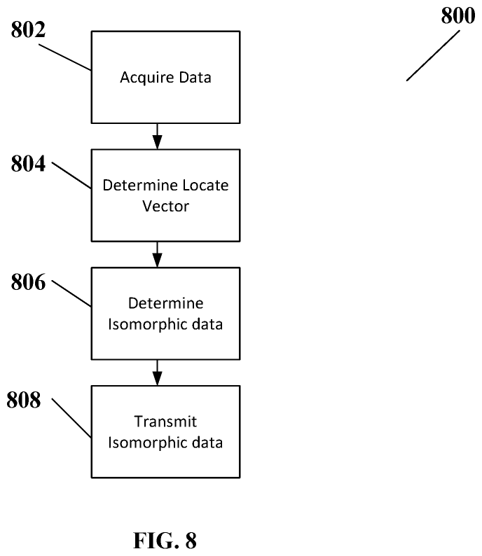

FIG. 8 illustrates a method 800 that can be executed on locate receiver 700 as illustrated in FIG. 7. Method 800 is executed with processor 704 executing instructions that are stored in memory 702.

As illustrated in FIG. 8, method 800 begins in step 802. In step 802, locate receiver 700 receives and analyzes data, including the locate data, the GNSS data, and operational data as discussed above. In step 804, locate receiver 700 compiles the data into a locate vector as discussed above. In step 806, locate receiver 700 determines isomorphic data from the locate vector. In step 808, the isomorphic data is transmitted as illustrated in FIGS. 4-6 above. Method 800 can be repeated until all of the data is transmitted to the cloud-based platform.

The above detailed description is provided to illustrate specific embodiments of the present invention and is not intended to be limiting. Numerous variations and modifications within the scope of the present invention are possible. The present invention is set forth in the following claims.

What is claimed is:

1. An underground line locator system, comprising:
a locator including an array of spaced apart low frequency magnetic sensors that receives signals, including magnetic signals emanating from an underground cable or pipe; and
a communication system that provides communications with a cloud-based platform that receives and stores data that includes the signals,
wherein the data transmission is an isomorphic data transmission.

2. The line locator system according to claim 1, wherein the communications system is a WiFi system.

3. The line locator system according to claim 1, wherein the communication system includes a mobile device communicating with the locator and providing WiFi connection with the cloud-based platform.

4. The line locator system according to claim 1, wherein the locator includes a Real Time Kinetic GNSS system for position location on the earth's surface.

5. The line locator system according to claim 4, wherein the locator receives RTK correction data from a ground base station or alternative GNSS corrections.

6. The line locator system of claim 1, wherein the locator communicates with a Cloud Webserver that includes an Internet-Of-Things (IOT) platform.

7. The line locator system of claim 1, wherein the communications system uses attribute-value pairing formats for data interchanges.

8. The line locator system of claim 1, wherein the communications system can include a smart phone communicating with the locator.

9. A method of transmitting data from a line location receiver, comprising:
acquiring data;
determining a locate vector from the data;
determining isomorphic data from the locate vector; and
transmitting the isomorphic data.

10. The method of claim 9, wherein transmitting the isomorphic data includes transmitting the isomorphic data using WiFi.

11. The method of claim 9, wherein transmitting the isomorphic data includes transmitting the isomorphic data to a mobile device.

12. The method of claim 9, wherein acquiring data includes acquiring locate data, operational data, and geolocation data.

13. A locate receiver, comprising:
a magnetic sensor array;
a processing circuit coupled to the magnetic sensor array;
a GPS antenna coupled to the processing circuit;
a communications interface coupled to the processing circuit; and
a memory coupled to the processing circuit, the memory storing instructions executable by the processing circuit to
acquire data from the magnetic sensor array and the GPS antenna,
determine a locate vector from the data,
determine isomorphic data from the locate vector, and
transmit the isomorphic data through the communications interface.

14. The locate receiver of claim 13, further including operational sensors including inertial sensors and wherein instructions to acquire data further include instructions to acquire data from the operational sensors.

15. The locate receiver of claim 13, wherein the communications interfaces includes a WiFi interface.

16. The locate receiver of claim 13, wherein the communications interface includes a Bluetooth interface to isomorphically transfer data to a mobile device.
